(19) United States
(12) Patent Application Publication
(10) Pub. No.: US 2018/0285643 A1
(43) Pub. Date: Oct. 4, 2018

(54) OBJECT RECOGNITION DEVICE AND OBJECT RECOGNITION METHOD

(71) Applicant: HONDA MOTOR CO., LTD., Tokyo (JP)

(72) Inventors: Mikio Nakano, Wako-shi (JP); Tomoyuki Sahata, Tokyo (JP)

(21) Appl. No.: 15/934,337

(22) Filed: Mar. 23, 2018

(30) Foreign Application Priority Data
Mar. 29, 2017 (JP) 2017-065865

(51) Int. Cl. G06K 9/00; G06K 9/32; G10L 15/16; G06N 3/02

(52) U.S. Cl. CPC G06K 9/00671; G06N 3/02; G10L 15/16; G06K 9/3241

(57) ABSTRACT

An object recognition device includes an imaging device configured to capture an image including a recognition target object, an image model configured to pre-accumulate image data, and an image recognition unit configured to authenticate the object of the captured image using the image captured by the imaging device and the image model, wherein when an unauthenticated object is present, the image recognition unit retrieves and acquires an image of the unauthenticated object via a network, generates the image data from the acquired image, and recognizes an object name of the object on the basis of the generated image data.

### CROSS-REFERENCE TO RELATED APPLICATION

Priority is claimed on Japanese Patent Application No. 2017-065865, filed Mar. 29, 2017, the content of which is incorporated herein by reference.

### BACKGROUND OF THE INVENTION

### Field of the Invention

The present invention relates to an object recognition device and an object recognition method.

### Description of Related Art

When a robot performs a task in a home environment, it is necessary to achieve at least an object gripping task of gripping an object indicated by a user. In such a task, for example, the user issues an instruction by speech and the robot performs object recognition on the basis of a speech recognition result of the user's speech. Also, the robot can acquire image information of an object around the robot through an imaging device.

As a system for recognizing such an object, a method of integrating speech information and image information has been proposed (for example, see Y. Ozasa et al., “Disambiguation in Unknown Object Detection by Integrating Image and Speech Recognition Confidences,” ACCV, 2012 (hereinafter referred to as Non-Patent Literature 1)). However, in the technology described in Non-Patent Literature 1, both a speech model and an image model are required when object recognition is performed. Although it is easy for the object recognition system to hold such a speech model, it is difficult to actually hold a large number of image models because the file size thereof is large.

Thus, as a system for recognizing an object, technology for recognizing a target object on the basis of speech likelihood and an image likelihood has been disclosed (for example, see Japanese Unexamined Patent Application, First Publication No. 2014-170295 (hereinafter referred to as Patent Literature 1)).

### SUMMARY OF THE INVENTION

In the technology disclosed in Patent Literature 1, a target image is read from an image model on the basis of a speech likelihood, and object recognition is performed on the basis of an image likelihood by reading an image from the web when there is no target image in the image model. However, in the technology disclosed in Patent Literature 1, retrieval of an image from the web is likely to be time-consuming and there is a problem of deterioration of an object recognition speed.

An aspect according to the present invention has been made in view of the above-described problems, and an objective of the aspect according to the present invention is to provide an object recognition device and an object recognition method capable of improving an object recognition speed.

In order to achieve the above-described objective, the present invention adopts the following aspects.

(1) According to an aspect of the present invention, an object recognition device includes an imaging device configured to capture an image including a recognition target object; an image model configured to pre-accumulate image data; and an image recognition unit configured to authenticate the object of the captured image using the image captured by the imaging device and the image model, wherein when an unauthenticated object is present, the image recognition unit retrieves and acquires an image of the unauthenticated object via a network, generates the image data from the acquired image, and recognizes an object name of the object on the basis of the generated image data.

(2) In the above-described aspect (1), if the recognition target object is recognized using the image acquired via the network, the image recognition unit may acquire the object name corresponding to the image when acquiring the image and may accumulate image data based on the acquired object name and the acquired image in the image model.

(3) In the above-described aspect (1) or (2), the image recognition unit may authenticate the image using a neural network.

(4) In the above-described aspect (3), the neural network may be a deep neural network (DNN) or a convolutional neural network (CNN).

(5) In any one of the above-described aspects (1) to (4), the image recognition unit may learn the object name through a dialog when the image for the authentication of the object is not acquired from the network.

(6) According to an aspect of the present invention, an object recognition method for use in an object recognition device having an image model configured to pre-accumulate image data includes an imaging step in which an imaging device captures an image including a recognition target object; a first image recognition step in which an image recognition unit authenticates the object of the captured image using the image captured in the imaging step and the image model; and a second image recognition step in which when an unauthenticated object is present, the image recognition unit retrieves and acquires an image of the unauthenticated object via a network, generates the image data from the acquired image, and recognizes an object name of the object on the basis of the generated image data.

According to the above-described aspects (1) and (6), any object for which an image model is not stored in an image model database (DB) 107 can be recognized using information on the Internet.

According to the above-described aspect (2), if an object for which an image model is not stored in the image model DB 107 is authenticated, information thereof can be stored in the image model DB 107 (locally) so that object recognition speed can be improved the next time.

Also, according to the above-described aspect (3), image recognition accuracy can be improved using a neural network.

Also, according to the above-described aspect (4), image recognition accuracy can be improved using deep learning, a DNN, or the like.

Also, according to the above-described aspect (5), even if an object for which an image model is not stored in the image model DB 107 is not recognized using information on the network, it is possible to perform learning through a dialogue with a human.

### BRIEF DESCRIPTION OF THE DRAWINGS

FIG. 1 is a block diagram illustrating an example of a configuration of an object recognition device according to the present embodiment.

FIG. 2 is a diagram illustrating an outline of deep learning.

FIG. 3 is a diagram illustrating an example of authentication performed by a neural network (NN) authentication unit according to the present embodiment.

FIG. 4 is a flowchart illustrating an example of a processing procedure of authenticating an image captured by the object recognition device according to the present embodiment.

FIG. 5 is a flowchart illustrating an example of a processing procedure of object recognition performed by the object recognition device according to the present embodiment.

FIG. 6 is a flowchart illustrating an example of a processing procedure of acquiring an image from an image server and generating an image model according to the present embodiment.

### DETAILED DESCRIPTION OF THE INVENTION

Hereinafter, embodiments of the present invention will be described with reference to the drawings.

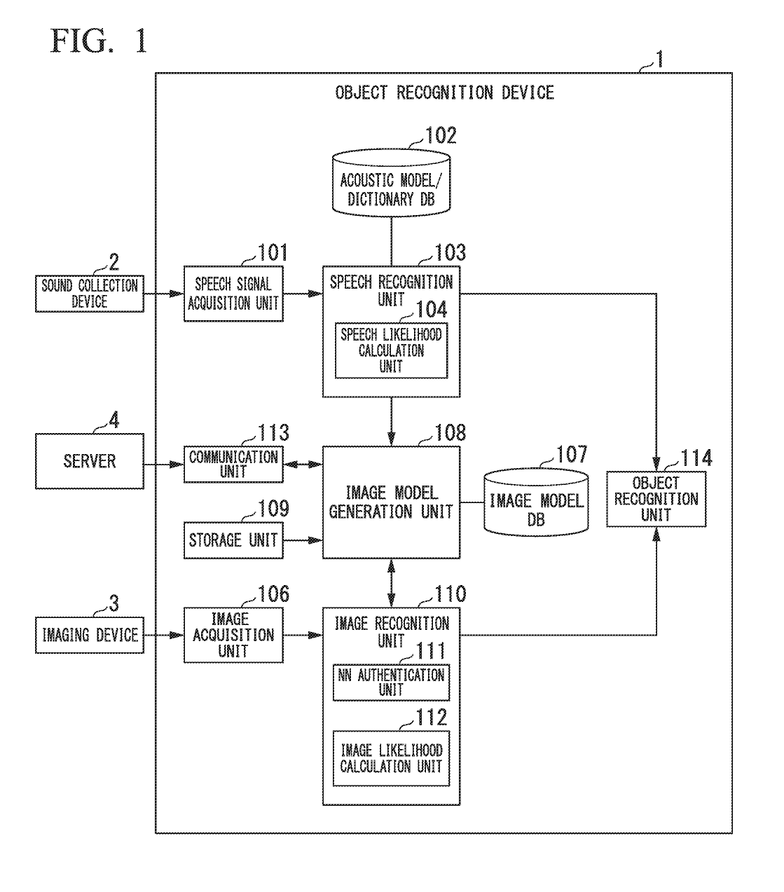

FIG. 1 is a block diagram illustrating an example of a configuration of an object recognition device 1 according to the present embodiment. As illustrated in FIG. 1, the object recognition device 1 includes a speech signal acquisition unit 101, an acoustic model/dictionary DB 102, a speech recognition unit 103, an image acquisition unit 106, an image model DB 107, an image model generation unit 108, a storage unit 109, an image recognition unit 110, a communication unit 113, and an object recognition unit 114. Also, the speech recognition unit 103 includes a speech likelihood calculation unit 104. The image recognition unit 110 includes an NN authentication unit 111 and an image likelihood calculation unit 112.

A sound collection device 2 and an imaging device 3 are connected to the object recognition device 1. The object recognition device 1 is connected to a server 4 via a network.

The sound collection device 2 is, for example, a microphone that collects a signal of a speech spoken by a user, converts the collected speech signal from an analog signal into a digital signal, and outputs the speech signal converted into the digital signal to the object recognition device 1. Also, the sound collection device 2 may be configured to output the speech signal having the analog signal to the object recognition device 1. The sound collection device 2 may be configured to output the speech signal to the object recognition device 1 via a wired cord or a cable, or may be configured to wirelessly transmit the speech signal to the object recognition device 1.

Also, the sound collection device 2 may be a microphone array. In this case, the sound collection device 2 includes P microphones arranged at different positions. Then, the sound collection device 2 generates acoustic signals of P channels (P is an integer of 2 or more) from the collected sound and outputs the generated acoustic signals of the P channels to the object recognition device 1.

The imaging device 3 is, for example, a charged coupled devices (CCD) image sensor camera, a complementary metal-oxide-semiconductor (CMOS) image sensor camera, or the like. The imaging device 3 captures an image and outputs the captured image to the object recognition device 1. Also, the imaging device 3 may be configured to output the image to the object recognition device 1 via a wired cord or a cable, or may be configured to wirelessly transmit the image to the object recognition device 1.

Images and speech information are associated and stored in the server 4. Also, resolutions of the images may be the same or different. The server 4 may be an arbitrary site on the Internet.

The object recognition device 1 recognizes the object using the acquired speech signal and image signal. For example, the object recognition device 1 is incorporated in a humanoid robot, a receiving device, an industrial robot, a smartphone, a tablet terminal, and the like.

Also, if the sound collection device 2 is a microphone array, the object recognition device 1 further includes a sound source localization unit, a sound source separation unit, and a sound source identification unit. In this case, in the object recognition device 1, the sound source localization unit performs sound source localization using a transfer function pre-generated for a speech signal acquired by the speech signal acquisition unit 101. Then, the object recognition device 1 identifies a speaker using a result of the localization by the sound source localization unit. The object recognition device 1 performs sound source separation on the speech signal acquired by the speech signal acquisition unit 101 using the result of the localization by the sound source localization unit. Then, the speech recognition unit 103 of the object recognition device 1 performs utterance section detection and speech recognition on the separated speech signal (see, for example, Japanese Unexamined Patent Application, First Publication No. 2017-9657). Also, the object recognition device 1 may be configured to perform an echo suppression process.

The speech signal acquisition unit 101 acquires a speech signal output by the sound collection device 2 and outputs the acquired speech signal to the speech recognition unit 103. Also, if the acquired speech signal is an analog signal, the speech signal acquisition unit 101 converts the analog signal into a digital signal and outputs the speech signal converted into the digital signal to the speech recognition unit 103.

In the acoustic model/dictionary DB 102, for example, an acoustic model, a language model, a word dictionary, and the like are stored. The acoustic model is a model based on a feature quantity of sound, and the language model is a model of information of words (vocabularies) and an arrangement thereof. The word dictionary is a dictionary based on a large number of vocabularies, for example, a large vocabulary word dictionary.

The speech recognition unit 103 acquires a speech signal output by the speech signal acquisition unit 101 and detects a speech signal of an utterance section from the acquired speech signal. For detection of the utterance section, for example, a speech signal having a predetermined threshold value or more is detected as the utterance section. Also, the speech recognition unit 103 may detect the utterance section using another well-known method. For example, the speech recognition unit 103 extracts a Mel-scale logarithmic spectrum (MSLS), which is an acoustic feature quantity, from a speech signal for each utterance section. Also, the MSLS is obtained using a spectral feature quantity as a feature quantity of acoustic recognition and performing an inverse discrete cosine transform on a Mel-frequency cepstrum coefficient (MFCC). Also, in the present embodiment, for example, the utterance is a word (vocabulary) having a name of an object such as “apple,” “motorcycle,” or “fork.”

The speech likelihood calculation unit 104 calculates a speech likelihood Lₛ(s;Λᵢ) using, for example, a hidden Markov model (HMM)) with reference to the acoustic model/dictionary DB 102 with respect to the extracted acoustic feature quantity. Also, the speech likelihood Lₛ(s;Λᵢ) is obtained by calculating a posteriori probability p(Λᵢ|s). Here, s is the acoustic feature quantity and Λᵢ is a speech model of an i^{th} object stored in the acoustic model/dictionary DB 102. Also, the speech likelihood Lₛ is a value from 0 to 1. It is indicated that a likelihood difference is larger with respect to a contention candidate and the reliability is higher when the speech likelihood Lₛ is closer to 1. Also, it is indicated that the reliability is lower when the speech likelihood Lₛ is closer to 0.

The speech recognition unit 103 determines candidates for a speech recognition result from the top rank of a likelihood calculated by the speech likelihood calculation unit 104 to a predetermined rank. As an example, the predetermined rank is a tenth rank. The speech recognition unit 103 outputs the speech likelihood Lₛ calculated by the speech likelihood calculation unit 104 to the object recognition unit 114.

Reference literature; www.ieice-hbkb.org/files/02/02gun_07hen_02.pdf (retrieved on the web on Mar. 19, 2017), Koichi Shinoda, Akinori Ito, Akinobu Lee, “Group 2 (image, sound, and language)—Volume 7 (speech recognition and synthesis) Chapter 2: speech recognition” ver. 1, the Institute of Electronics, Information and Communication Engineers (IEICE) “Knowledge Base,” IEICE, 2010, pp. 2 to 12

The image acquisition unit 106 acquires an image output by the imaging device 3 and outputs the acquired image to the image recognition unit 110.

In the image model DB 107, an image model is stored. The image model is a model based on a feature quantity of the image. Also, the image model DB 107 may store images. In this case, it is preferable for resolutions of the images to be the same. When the resolutions are different, the image model generation unit 108 generates an image model by normalizing the resolutions.

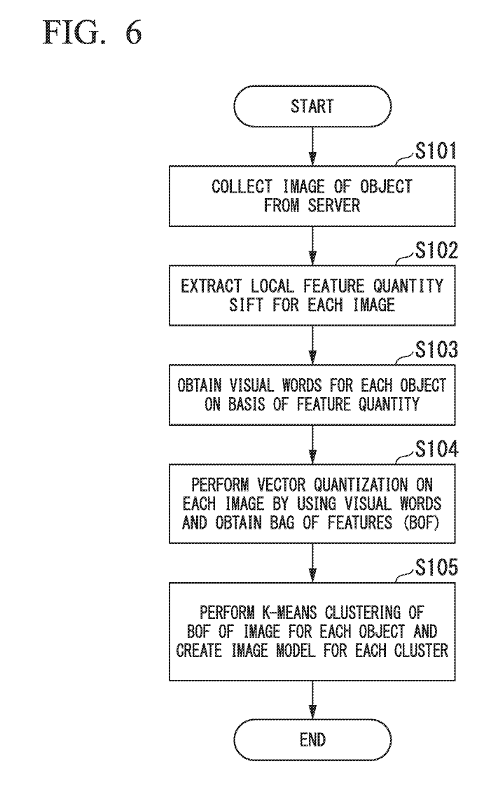

When an image is authenticated, the image model generation unit 108 retrieves an image model stored in the image model DB 107 in accordance with an instruction from the image recognition unit 110. Also, if a retrieval result indicates that an image model necessary for authentication is not stored in the image model DB 107, the image model generation unit 108 acquires image and speech information from the server 4 or the network (the Internet) using a uniform resource indicator (URL) address stored in the storage unit 109 via the communication unit 113 in accordance with an instruction from the image recognition unit 110. Also, the URL address accessed by the communication unit 113 may be stored in the image model generation unit 108 or the communication unit 113. More specifically, if the image model of “glass beads” is not stored in the image model DB 107, the image model generation unit 108 acquires at least one image of “glass beads.” Also, the image model generation unit 108 may be configured to acquire a resolution of the acquired image and normalize the acquired resolution when the acquired resolution is different from a predetermined value. The image model generation unit 108 extracts a feature quantity of the acquired image and generates an image model using the extracted feature quantity. A method of generating an image model using an image acquired from the server 4 or the network (the Internet) will be described below with reference to FIG. 6.

The image model generation unit 108 outputs the image model acquired from the image model DB 107 or the generated image model to the image recognition unit 110 in descending order of speech likelihoods.

The storage unit 109 stores a URL address of the server 4.

The image recognition unit 110 calculates an image feature quantity of an image output by the imaging device 3. Also, the image feature quantity may be, for example, at least one of a wavelet for the entire target object, a scale-invariant feature transform (SIFT) feature quantity or a speeded up robust features (SURF) feature quantity for local information of the target object, Joint HOG, which is a joint of local information, and the like. Also, the image recognition unit 110 may be configured to calculate an image feature quantity for an image obtained by performing horizontal inversion on the image output by the imaging device 3.

The NN authentication unit 111 performs image authentication on the image model stored in the image model DB 107, through, for example, a DNN using the calculated feature quantity. Also, the NN authentication unit 111 may use another neural network, for example, a CNN or the like. At a time of authentication, the NN authentication unit 111 initially authenticates the image model stored in the image model DB 107 using, for example, the DNN. The NN authentication unit 111 outputs an acquisition instruction to the image model generation unit 108 when it is not possible to perform authentication using the image model stored in the image model DB 107. Also, the acquisition instruction includes an object name, which is a candidate for the recognition result of the speech recognition unit 103. Thereby, the NN authentication unit 111 acquires an image from the server 4 or the network via the image model generation unit 108 and the communication unit 113. The NN authentication unit 111 performs authentication using the image model generated by the image model generation unit 108 from the acquired image. The NN authentication unit 111 outputs information indicating the authentication result to the object recognition unit 114. The DNN will be described below.

The image likelihood calculation unit 112 calculates an image likelihood Lᵥ(v;oᵢ) for each candidate using the calculated image feature quantity and the image models output by the image model generation unit 108, for example, the HMM. Alternatively, the image likelihood calculation unit 112 calculates an image likelihood Lᵥ(v;oᵢ) for each candidate using the calculated image feature quantity and the image models authenticated by the DNN from the image model DB 107, for example, the HMM. Also, the image likelihood Lᵥ(v;oᵢ) is obtained by calculating a posterior probability p(oᵢ|v). Here, v is an image feature quantity, and oᵢ is an image model of an i^{th} object output by the image model generation unit 108. Also, the image likelihood Lᵥ is a value from 0 to 1. It is indicated that a likelihood difference is larger with respect to a contention candidate and the reliability is higher when the image likelihood Lᵥ is closer to 1. Also, it is indicated that the reliability is lower when the image likelihood Lᵥ is closer to 0.

The image recognition unit 110 determines candidates for an image recognition result from the top rank of a likelihood calculated by the image likelihood calculation unit 112 to a predetermined rank. As an example, the predetermined rank is a tenth rank. The image recognition unit 110 outputs the image likelihood Lᵥ calculated by the image likelihood calculation unit 112 to the object recognition unit 114.

Also, the image recognition unit 110 recognizes an object name of a recognition target using an object name acquired from the server 4 or the network (the Internet) via the image model generation unit 108 and the communication unit 113 when the object of the captured image is authenticated using the image acquired from the server 4 or the network (the Internet). The image recognition unit 110 outputs information indicating the recognized object name to the object recognition unit 114.

In accordance with control of the image model generation unit 108, the communication unit 113 accesses the server 4 or the network (the Internet) and acquires an image.

The object recognition unit 114 recognizes an object on the basis of the information indicating the object name output by the image recognition unit 110.

Using the speech likelihood Lₛ output by the speech recognition unit 103 and the image likelihood Lᵥ output by the image recognition unit 110, the object recognition unit 114 performs integration according to a logistic function of the following Equation (1) to obtain an object likelihood F_{L} for each candidate.

$${F}_{L} ( {L}_{s} , {L}_{v} ) = \frac{1}{1 + {e}^{- ( {α}_{0} + {α}_{1} {L}_{s} + {α}_{2} {L}_{v} )}} \qquad ( 1 )$$

In Equation (1), v is an input image, oᵢ is an i^{th} image model, and α₀, α₁, and α₂ are parameters of the logistic function.

The object recognition unit 114 estimates a candidate î having a maximum object likelihood F_{L} calculated using the following Equation (2).

$$\hat{i} = {arg}_{i} max {F}_{L} ( {L}_{s} ( s ; {Λ}_{i} ) , {L}_{v} ( v ; {o}_{i} ) ) \qquad ( 2 )$$

Also, in Equation (2), arg max F_{L}( . . . ) is a function for providing F_{L} that maximizes . . . .

Also, although an example in which the speech likelihood Lₛ and the image likelihood Lᵥ are integrated using a logistic function has been described in the above-described example, the present invention is not limited thereto. They may be integrated using other functions.

Here, an outline of the SIFT feature quantity will be described.

A process of the SIFT is roughly divided into two steps of detection of feature points and description of feature quantities. In the detection of feature points, a point considered as an image feature (a key point) is determined from a difference between smoothed images with different scales. Then, information is described using the gradient information of a surrounding image around each key point. Next, by calculating a difference between the scales, a position of appearance of a change in the image (a boundary between an object and a background or the like) is calculated. A point at which this change is maximized is a candidate for a feature point (a key point) of the SIFT. In order to retrieve this point, differential images are arranged and extreme values are retrieved. The SIFT feature is obtained by describing an image gradient around this key point.

Next, an outline of deep learning will be explained.

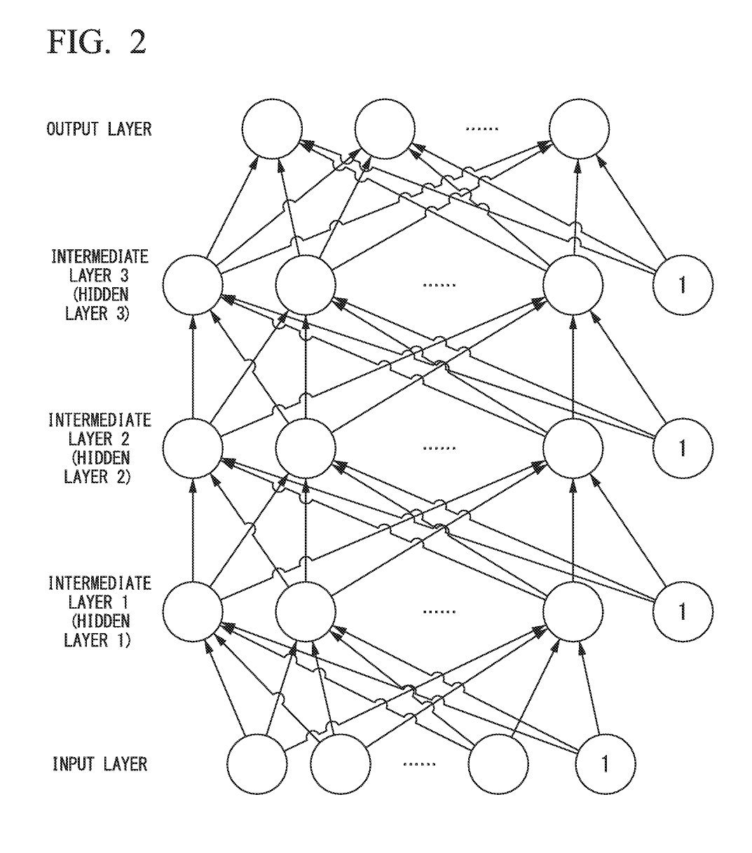

FIG. 2 is a diagram illustrating the outline of deep learning.

Deep learning is learning using a multilayer structure neural network (DNN). The example illustrated in FIG. 2 is an example having three hidden layers (intermediate layers). As described above, using the multilayer structure, complicated nonlinear processing can be implemented by stacking simple nonlinear networks in multiple stages. The NN authentication unit 111 authenticates an image captured using the DNN. Such learning is performed using feature quantities extracted from images.

Next, an example of authentication performed by the NN authentication unit 111 will be described.

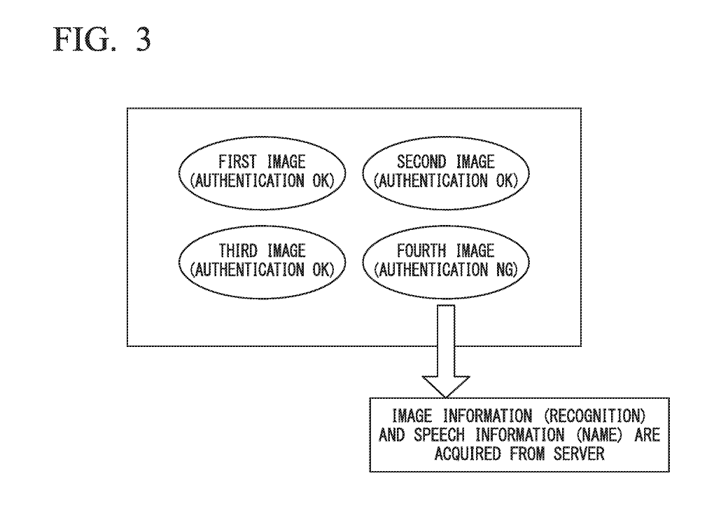

FIG. 3 is a diagram illustrating an example of authentication performed by the NN authentication unit 111 according to this embodiment. The example illustrated in FIG. 3 is an example in which four images (first to fourth images) are sequentially captured.

The NN authentication unit 111 authenticates the captured first image. More specifically, authentication is performed through the DNN using a feature quantity of the first image and an image model of the image data DB 107.

A result of authenticating the first image is authentication OK (=authentication succeeds).

Next, the NN authentication unit 111 performs authentication on the captured second image using the image model of the image data DB 107. The result of authenticating the second image is authentication OK.

Next, the NN authentication unit 111 performs authentication on the captured third image using the image model of the image data DB 107. The result of authenticating the third image is authentication OK.

Next, the NN authentication unit 111 performs authentication using the image model of the image data DB 107 on the captured fourth image. The result of authenticating the fourth image is authentication NG (=authentication fails).

Because the authentication is NG, the NN authentication unit 111 acquires image information (an image, a feature quantity of an image, or an image model) from the server 4 or the network. The NN authentication unit 111 outputs an instruction for further acquiring speech information (text information of the object name) corresponding to the acquired image information to the image model generation unit 108.

Next, an example of a processing procedure of authenticating an image captured by the object recognition device 1 will be described.

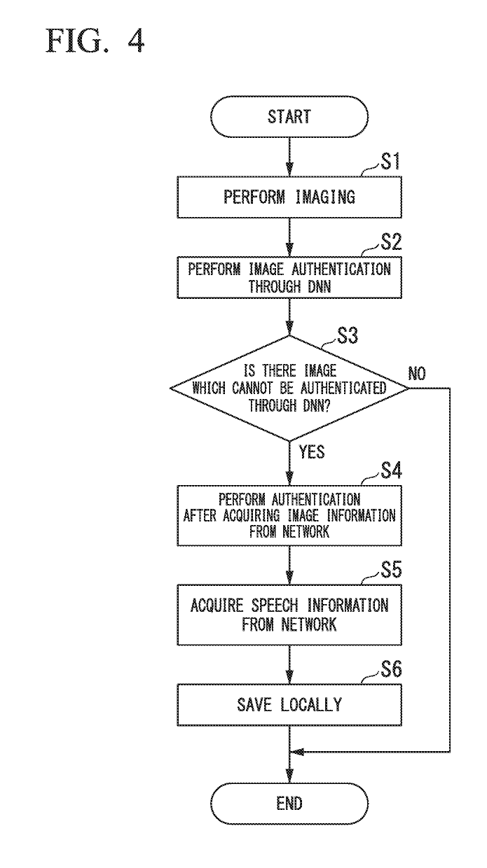

FIG. 4 is a flowchart illustrating an example of a processing procedure of authenticating an image captured by the object recognition device 1 according to the present embodiment. The example illustrated in FIG. 4 is an example in which the NN authentication unit 111 recognizes an object using the DNN.

(Step S1) The imaging device 3 captures an image including a target object and outputs the captured image to the object recognition device 1. Subsequently, the object recognition device 1 acquires the image output from the imaging device 3.

(Step S2) The NN authentication unit 111 performs image authentication of the object corresponding to the captured image using a feature quantity of the image and an image model stored in the image model DB 107 through a DNN.

(Step S3) The NN authentication unit 111 determines whether the image cannot be authenticated through the DNN using the image model stored in the image model DB 107. When the NN authentication unit 111 determines that the image can be authenticated through the DNN (step S3; NO), the process ends. If the NN authentication unit 111 determines that the image cannot be authenticated through the DNN (step S3; YES), the process proceeds to step S4.

(Step S4) The NN authentication unit 111 acquires an image from the server 4 or the network via the image model generation unit 108 and the communication unit 113, and authenticates the captured image using an image model generated by the image model generation unit 108 from the acquired image. Also, a plurality of images may be authenticated by the NN authentication unit 111.

(Step S5) The NN authentication unit 111 acquires speech information (an object name) corresponding to the image that can be authenticated from the server 4 or the network via the image model generation unit 108 and the communication unit 113. Also, if there are a plurality of authenticated images, the NN authentication unit 111 acquires speech information corresponding thereto.

(Step S6) The NN authentication unit 111 stores the acquired speech information in the acoustic model/dictionary DB 102 via the image model generation unit 108 and the speech recognition unit 103.

Accordingly, the image authentication process is completed.

If the object recognition device 1 does not recognize the target object in the process illustrated in FIG. 4, the user causes learning to be performed by associating the object name with the captured image and the acquired speech signal through a dialog with the object recognition device 1.

Next, an example of a processing procedure performed by the object recognition device 1 will be described.

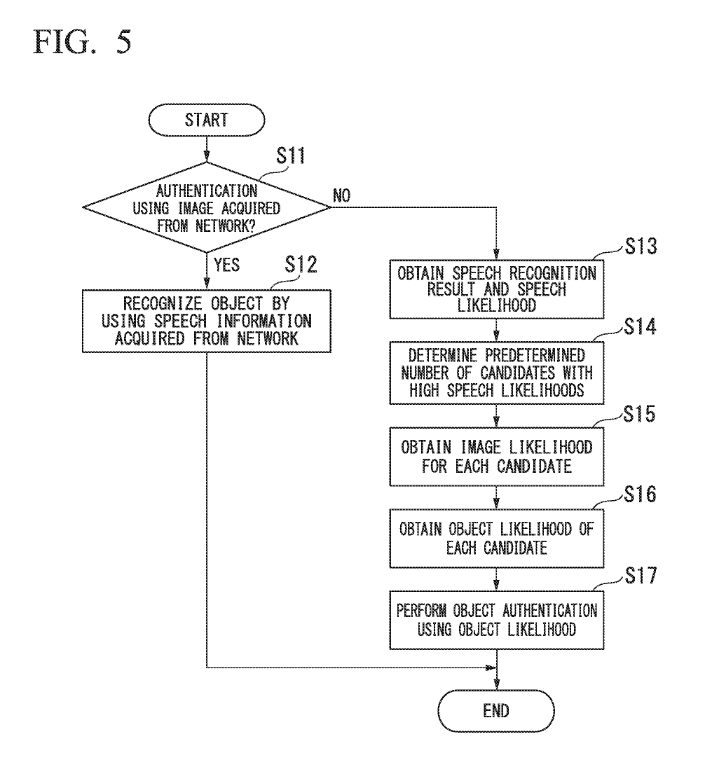

FIG. 5 is a flowchart illustrating an example of a processing procedure of object recognition by the object recognition device 1 according to the present embodiment. Also, the process illustrated in FIG. 5 is performed if the NN authentication unit 111 cannot authenticate a image captured using an image stored in the image model DB 107.

(Step S11) The object recognition unit 114 determines whether the captured image can be authenticated using an image acquired from the server 4 or the network. If it is determined that authentication can be performed using the image acquired from the server 4 or the network (step S11; YES), the object recognition unit 114 proceeds to the processing of step S12. If it is determined that authentication cannot be performed using the image acquired from the image model DB 107 (step S11; NO), the object recognition unit 114 proceeds to the processing of step S13.

(Step S12) The object recognition unit 114 recognizes the object on the basis of information indicating the object name output by the image recognition unit 110. The object recognition unit 114 terminates the process.

(Step S13) The speech recognition unit 103 extracts an acoustic feature quantity from a speech signal acquired by the speech signal acquisition unit 101 from the sound collection device 2. Subsequently, the speech recognition unit 103 calculates a speech likelihood Lₛ(s;Λᵢ) using, for example, an HMM, with reference to the acoustic model/dictionary DB 102 with respect to the extracted acoustic feature quantity.

(Step S14) The speech recognition unit 103 determines candidates for a speech recognition result from the top rank of a likelihood calculated by the speech likelihood calculation unit 104 to a predetermined rank.

(Step S15) The image likelihood calculation unit 112 calculates the image likelihood Lᵥ(v;oᵢ) using the image feature quantity of the captured image and the image model authenticated by the NN authentication unit 111, for example, the HMM. When the NN authentication unit 111 authenticates a plurality of images, the image likelihood calculation unit 112 calculates the image likelihood Lᵥ(v;oᵢ) of each of the authenticated images.

(Step S16) Using the speech likelihood Lₛ output by the speech recognition unit 103 and the image likelihood Lᵥ output by the image recognition unit 110, the object recognition unit 114 performs integration according to a logistic function of the above-described Equation (1) to obtain an object likelihood F_{L} for each candidate.

(Step S17) The object recognition unit 114 authenticates an object by obtaining a candidate for which the object likelihood F_{L} calculated using the above-described Equation (2) becomes maximum.

Accordingly, the process of object recognition of the object recognition device 1 is completed.

Also, although an example in which an object is recognized using speech information acquired from the server 4 or the network if a captured image can be authenticated on the basis of the image acquired from the server 4 or the network has been described in the example illustrated in FIG. 5, the present invention is not limited thereto. In such a case, the object recognition device 1 may also be configured to perform the processing of steps S13 to S17. In this case, in step S15, the image likelihood calculation unit 112 calculates the image likelihood Lᵥ(v;oᵢ) using the image feature quantity of the captured image and the image model generated from the image acquired from the server 4 or the network, for example, the HMM.

Next, an example of a processing procedure of generating an image model by acquiring an image from the server 4 will be described.

FIG. 6 is a flowchart illustrating an example of a processing procedure of acquiring an image from the server 4 and generating an image model according to the present embodiment.

(Step S101) The image model generation unit 108 acquires (collects) images of objects corresponding to candidates for a recognition result from the server 4.

(Step S102) For example, the image model generation unit 108 extracts an SIFT feature quantity for an image of each of the candidates.

(Step S103) The image model generation unit 108 obtains visual words for each object on the basis of the SIFT feature quantity. Here, the visual words will be described. For example, in a bag of features (BoF), SIFT features and SURF features are extracted from images of objects and are classified into W clusters according to a k-means method. A vector serving as the centroid (the center of gravity) of each cluster is referred to as a visual word and the number thereof is determined empirically. Specifically, the image model generation unit 108 executes k-means clustering (a K average method) of SIFT feature quantities of all images, and sets centers of clusters as the visual words. Also, the visual words correspond to a typical local pattern.

(Step S104) The image model generation unit 108 performs vector quantization on each candidate image using the visual words to obtain a BoF representation of each image. The BoF representation represents an image according to appearance frequencies (histograms) of the visual words.

(Step S105) The image model generation unit 108 performs k-means clustering of the BoF for each object of a recognition candidate and generates an image model for each cluster.

Although an example in which the image model generation unit 108 acquires an image from the server 4 to generate an image model when an image of a candidate for a speech recognition result is not stored in the image model DB 107 in the above-described example has been described, the present invention is not limited thereto. The image model generation unit 108 may be configured to acquire an image from the server 4 even when an image of a candidate for a speech recognition result is stored in the image model DB 107. In this case, the image model generation unit 108 may be configured to generate a second image model for a second image acquired from the server 4. The image model generation unit 108 may be configured to output a first image model acquired from the image model DB 107 and the generated second image model to the image recognition unit 110. Then, the image likelihood calculation unit 112 may be configured to calculate image likelihoods of the first image model and the generated second image model and select the image model having a higher image likelihood.

As described above, in the present embodiment, information (a photo) imaged by the imaging device is first authenticated in an image model stored in the image model DB 107 through the DNN and image information and speech information are acquired from the Internet if the information is not authenticated and learned. Also, in the present embodiment, learned details may be saved locally. Also, in the present embodiment, if a target image is not be found on the Internet, learning is made (a speech and an image) through a dialog between the object recognition device 1 and the user.

Thereby, according to the present embodiment, any object for which an image model is not stored in the image model DB 107 can be recognized using information on the Internet.

Also, according to the present embodiment, if an object for which an image model is not stored in the image model DB 107 is authenticated, information thereof can be stored in the image model DB 107 (locally), so that the object recognition speed can be improved from the next time.

Also, according to the present embodiment, image recognition accuracy can be improved using depth learning, the DNN, or the like.

Also, according to the present embodiment, even if an object for which an image model is not stored in the image model DB 107 is not recognized using information on the Internet, it is possible to perform learning through a dialogue with a human.

Although an example in which the sound collection device 2 and the imaging device 3 are connected to the object recognition device 1 has been described in the above-described example, the sound collection device 2 and the imaging device 3 may be provided in the object recognition device 1.

Also, all or a part of processing to be performed by the object recognition device 1 may be performed by recording a program for implementing all or some of the functions of the object recognition device 1 according to the present invention on a computer-readable recording medium and causing a computer system to read and execute the program recorded on the recording medium. Also, the “computer system” used here is assumed to include an operating system (OS) and hardware such as peripheral devices. In addition, the computer system is assumed to include a homepage providing environment (or displaying environment) when a World Wide Web (WWW) system is used. In addition, the computer-readable recording medium refers to a storage device, including a flexible disk, a magneto-optical disc, a read only memory (ROM), a portable medium such as a compact disc (CD)-ROM, and a hard disk embedded in the computer system. Further, the “computer-readable recording medium” is assumed to include a computer-readable recording medium for holding the program for a predetermined time as in a volatile memory (a random access memory (RAM)) inside the computer system including a server and a client when the program is transmitted via a network such as the Internet or a communication circuit such as a telephone circuit.

Also, the above-described program may be transmitted from a computer system storing the program in a storage device or the like via a transmission medium or transmitted to another computer system by transmission waves in a transmission medium. Here, the “transmission medium” for transmitting the program refers to a medium having a function of transmitting information, such as a network (a communication network) like the Internet or a communication circuit (a communication line) like a telephone circuit. Also, the above-described program may be a program for implementing some of the above-described functions. Further, the above-described program may be a program capable of implementing the above-described function in combination with a program already recorded on the computer system, i.e., a so-called differential file (differential program).

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An object recognition device, comprising:
an imaging device configured to capture an image including a recognition target object;
an image model configured to pre-accumulate image data; and
an image recognition unit configured to authenticate the object of the captured image using the image captured by the imaging device and the image model,
wherein when an unauthenticated object is present, the image recognition unit retrieves and acquires an image of the unauthenticated object via a network, generates the image data from the acquired image, and recognizes an object name of the object on the basis of the generated image data.

2. The object recognition device according to claim 1, wherein if the recognition target object is recognized using the image acquired via the network, the image recognition unit acquires the object name corresponding to the image when acquiring the image and accumulates image data based on the acquired object name and the acquired image in the image model.

3. The object recognition device according to claim 1, wherein the image recognition unit authenticates the image using a neural network.

4. The object recognition device according to claim 3, wherein the neural network is a deep neural network (DNN) or a convolutional neural network (CNN).

5. The object recognition device according to claim 1, wherein the image recognition unit learns the object name through a dialog when the image for the authentication of the object is not acquired from the network.

6. An object recognition method for use in an object recognition device having an image model configured to pre-accumulate image data, the object recognition method comprising:
an imaging step in which an imaging device captures an image including a recognition target object;
a first image recognition step in which an image recognition unit authenticates the object of the captured image using the image captured in the imaging step and the image model; and
a second image recognition step in which when an unauthenticated object is present, the image recognition unit retrieves and acquires an image of the unauthenticated object via a network, generates the image data from the acquired image, and recognizes an object name of the object on the basis of the generated image data.
